(19) United States
(12) Patent Application Publication
(10) Pub. No.: US 2005/0218084 A1
(43) Pub. Date: Oct. 6, 2005

(54) Enhanced photocatalytic system

(75) Inventors: Chan Ming Leung, Kowloon (HK); Hong Chua, Kowloon (HK)

Correspondence Address: COOPER & DUNHAM, LLP, 1185 AVENUE OF THE AMERICAS, NEW YORK, NY, 10036, US

(73) Assignee: Acumen Environmental Engineering and Technologies Co., Ltd.

(21) Appl. No.: 11/094,070

(22) Filed: Mar. 30, 2005

(30) Foreign Application Priority Data
Mar. 31, 2004 (HK) 04102352.4

(51) Int. Cl. C02F 1/30

(52) U.S. Cl. 210/748; 210/758

(57) ABSTRACT

A catalytic system for enhancing photocatalytic oxidation reaction in a fluid environment. The catalytic system includes a photocatalytic oxidation apparatus for purifying and disinfecting fluid and an electro-activator connected to the photocatalytic oxidation apparatus. The fluid passes through the electro-activator and the photocatalytic oxidation apparatus during operation. The photocatalytic oxidation apparatus includes a titanium dioxide-coated surface for receiving light. The electro-activator includes a pair of electrodes electrically connected to an electrical power source. The electrodes include an anode and a cathode generating an electric field therebetween. The anode includes a semiconductor material capable of generating chemically active substances to enhance photocatalytic activity of the photocatalytic oxidation apparatus and converting scaling ions in the fluid to particles that do not adhere to the titanium dioxide-coated surface of the photocatalytic oxidation apparatus to prevent scaling thereof.

### FIELD OF INVENTION

The present invention is related to a catalytic system. In particular, the present invention is related to a catalytic system for enhancing photocatalytic reaction in a fluid environment.

### BACKGROUND OF INVENTION

Pathogenic microbes, organic and inorganic pollutants are commonly found in water of various sources. Disinfection and purification of water are required for direct human consumption as well as for industrial and agricultural processes that produce products to be consumed by human or animals. Numerous ways have been used to disinfect water, for example, chlorination and ozonation. It is already known that radicals produced by photocatalytic oxidation process can oxidize organic pollutants contained within water. Hydroxyl radical, one of the end products of the above photocatalytic reaction is an extremely potent oxidizing agent as compared to chlorine and ozone and is capable of oxidizing all organic compounds. Furthermore, hydroxyl radicals also kill and breakdown microorganisms.

Photocatalysts that have been demonstrated for the destruction of organic pollutants in fluid include but are not limited to TiO₂, ZnO, SnO₂, WO₃, CdS, ZrO₂, SB₂O₄ and Fe₂O₃. Titanium dioxide is chemically stable and has a suitable bandgap for ultraviolet/visible photoactivation, and is relatively inexpensive. Therefore, phototocatalytic chemistry of titanium dioxide has been extensively studied over the last thirty years for removal of organic and inorganic compounds from contaminated air and water.

U.S. Patent Application No. 2003/0209501 discloses a method and apparatus for the purification and disinfection of liquid utilizing photocatalytic oxidation process between ultraviolet light and titanium dioxide. The photocatalytic oxidation apparatus can be applied to drinking water treatment systems, aquariums, seawater and freshwater fish tanks, swimming pools, fluid disinfection systems, commercial and industrial water supply systems, waste water treatment systems, and sewage treatment systems. FIG. 1 illustrates an example of how the photocatalytic oxidation apparatus 20 can be used with a common water treatment. The untreated water passes through the filter system 22, and the filtered water then passes through the photocatalytic oxidation apparatus 20 to decompose organic and inorganic contaminants and kill the microorganisms by photocatalytic oxidation of ultraviolet and titanium dioxide to ensure that the water is safe and reliable before leaving the water treatment system 24.

Referring to FIGS. 2A and 2B, an embodiment of the photocatalytic oxidation apparatus 20 is shown. The photocatalytic oxidation apparatus 20 includes two seal lid 26 and 28 on each end of a container 30 with an inlet 32 on one end and an outlet 34 on the other end. The photocatalytic oxidation apparatus 20 also includes a disinfectant core having a spiral shape metal plate 36 with titanium dioxide coating on both sides and installed around an ultraviolet lamp 38. The ultraviolet lamp 38 is aligned axially along the central axis of the container 30. In order to protect the ultraviolet lamp 38 against the damage induced by the fluid, the external surface of the ultraviolet lamp 38 can be surrounded by protective sleeve 40 made of quartz or glass. The inner surface of the container 30 is also coated with titanium dioxide and is adapted for exposure of the ultraviolet light from the ultraviolet lamp 38 during operation to increase the total effective contact surface area. In order to maximize the total effective contact surface area, the inner surfaces of inlet 32 and outlet 34 can also be coated with titanium dioxide.

During operation, the fluid enters container 30 through inlet 32 and flows along the spiral flow conduit 42 formed by the metal plate 36 with the inner wall of the container 30. Ultraviolet light from the ultraviolet lamp 38 irradiates the titanium dioxide coated on the metal plate 36 and the inner wall of the container 30 to generate photocatalytic oxidation. The free radicals produced by the photocatalytic oxidation oxidize and decompose organic and inorganic contaminants in the water. The free radicals also kill microorganisms such as Escherichia coli, Vibriocholerae and other pathogenic organisms in the fluid.

However, scaling ions (e.g. calcium ions, magnesium ions, or combination thereof) in the water would form large, irregularly shaped acicular crystals, usually known as water scales, on the titanium dioxide-coated surfaces of the photocatalytic oxidation apparatus. The water scales prevent titanium dioxide from receiving sufficient ultraviolet light, and therefore the efficiency of the photocatalytic oxidation reaction is reduced.

### SUMMARY OF INVENTION

The present invention is directed to a catalytic system for enhancing photocatalytic oxidation reaction in a fluid environment. The catalytic system includes a photocatalytic oxidation apparatus for purifying and disinfecting fluid and an electro-activator connected to the photocatalytic oxidation apparatus. The fluid passes through the electro-activator and the photocatalytic oxidation apparatus during operation. The photocatalytic oxidation apparatus includes a titanium dioxide-coated surface for receiving light. The electro-activator includes a pair of electrodes electrically connected to an electrical power source. The electrodes include an anode and a cathode generating an electric field therebetween. The anode includes a semiconductor material capable of generating chemically active substances to the fluid to enhance photocatalytic activity of the photocatalytic oxidation apparatus. The semiconductor material is also capable of converting scaling ions in the fluid to particles that do not adhere to the titanium dioxide-coated surface of the photocatalytic oxidation apparatus to prevent scaling thereof.

The present invention is also directed to a method of enhancing photocatalytic oxidation reaction in a fluid environment. The method includes providing a photocatalytic oxidation apparatus for purifying and disinfecting fluid and providing an electro-activator connected to the photocatalytic oxidation apparatus. The photocatalytic oxidation apparatus includes a titanium dioxide-coated surface for receiving light. The electro-activator includes an anode and a cathode. The anode is coated with or constructed of a semiconductor material. During operation, the fluid passes through the electro-activator and the photocatalytic oxidation apparatus, and an electric field is generated between the anode and the cathode. The anode then generates chemically active substances to the fluid to enhance photocatalytic activity of the photocatalytic oxidation apparatus, and converts scaling ions in the fluid to particles that do not adhere to the titanium dioxide-coated surface of the photocatalytic oxidation apparatus to prevent scaling thereof as well.

### BRIEF DESCRIPTION OF FIGURES

FIG. 1 is a schematic illustration showing the integration of a prior art photocatalytic oxidation apparatus for purifying and disinfecting fluid into a common water treatment system.

FIG. 2A is a schematic illustration showing an embodiment of the photocatalytic oxidation apparatus of FIG. 1.

FIG. 2B is the cross-sectional view along line X-X of the photocatalytic oxidation apparatus of FIG. 2A.

FIG. 3A is a schematic top view of an electro-activator including a pair of electrodes electrically connected to an electrical power source.

FIG. 3B is a schematic side view of the electro-activator of FIG. 3A.

FIG. 4 is a schematic view of a catalytic system for enhancing photocatalytic oxidation reaction in a fluid environment in accordance with the present invention.

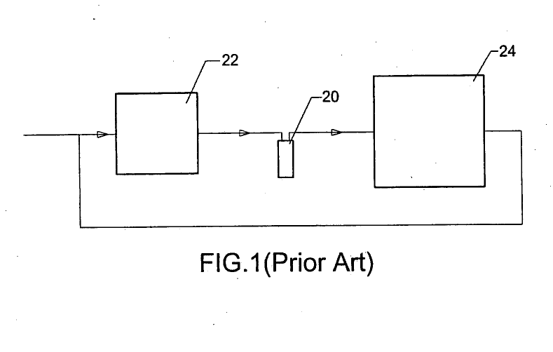

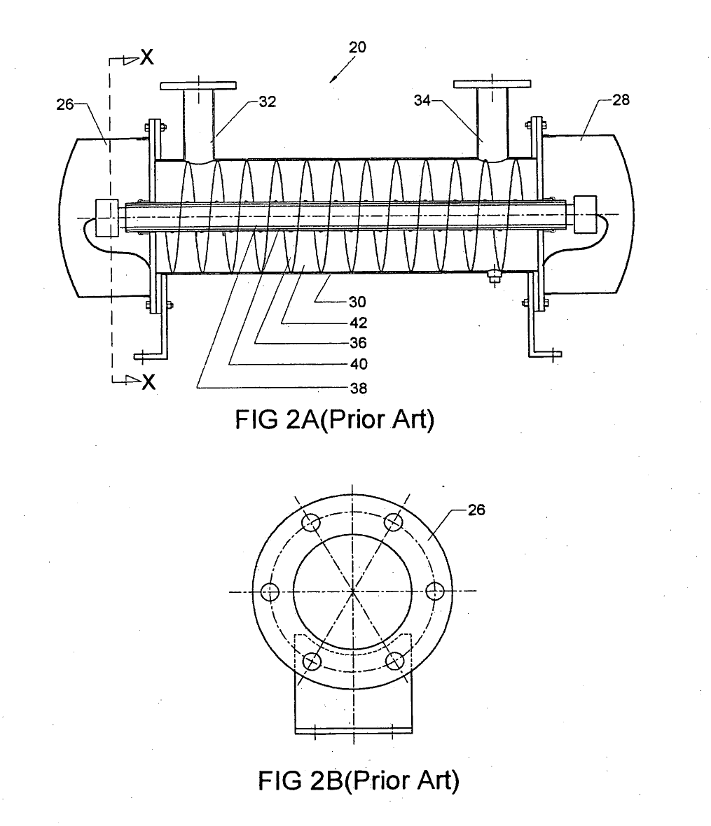

### DETAILED DESCRIPTION

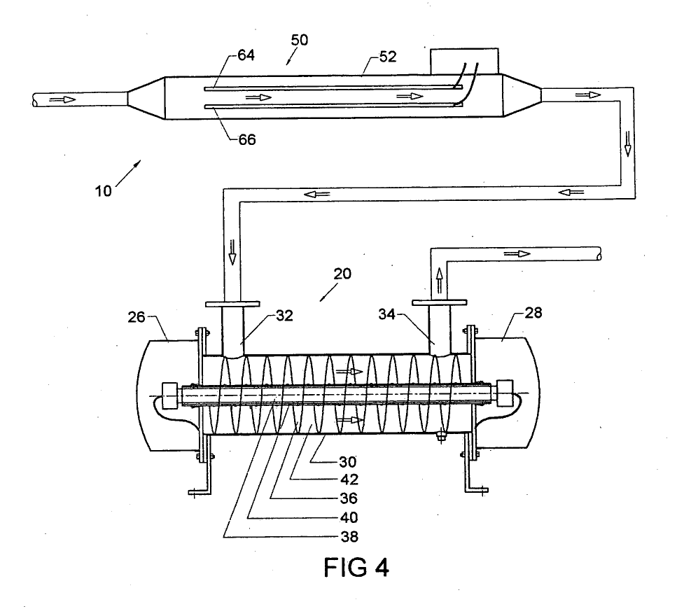

Referring now to FIG. 4, a catalytic system 10 for enhancing photocatalytic oxidation reaction in a fluid environment in accordance with the present invention is illustrated. The catalytic system 10 generally includes a photocatalytic oxidation apparatus 20 for purifying and disinfecting fluid and an electro-activator 50. In the illustrated embodiment, the photocatalytic oxidation apparatus 20 can be the one described in the BACKGROUND OF INVENTION section. It is to be understood that other types of the photocatalytic oxidation apparatus, including but not limited to, the other embodiments disclosed in U.S. Patent Application No. 2003/0209501 can also be used with the electro-activator 50 in the catalytic system 10 to enhance the photocatalytic oxidation reaction.

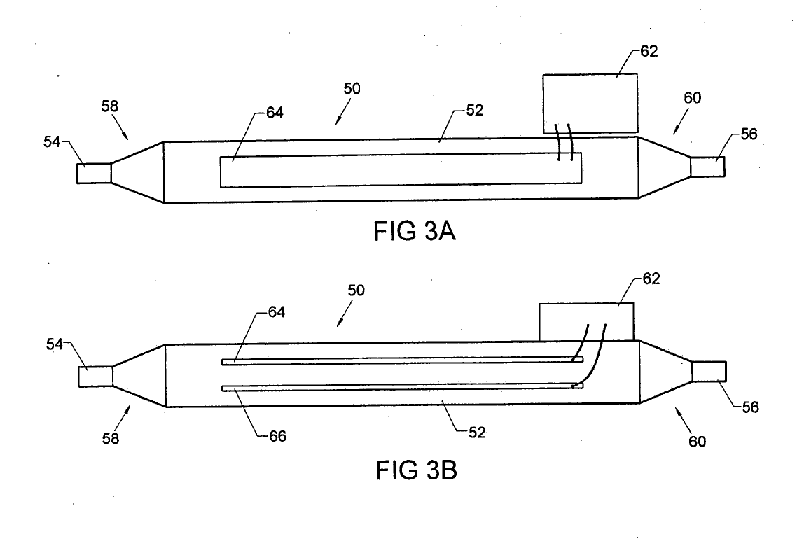

Referring to FIGS. 3A and 3B, the electro-activator 50 includes a housing 52 with an inlet 54 on one end 58 and an outlet 56 on the other end 60. A pair of electrodes, including an anode 64 and a cathode 66, is positioned inside the housing 52 and electrically connected to an electrical power source 62. The anode 64 is coated with semiconductor material. In the illustrated embodiment, the anode 64 is constructed of titanium coated with the semiconductor material, such as ruthenium oxide, iridium oxide, manganese oxide, nickel oxide, or combination thereof. A modifier, such as Gadolinium can be added to the semiconductor material. It is to be understood that other semiconductor materials can also be used to achieve the results described below.

Referring back to FIG. 4, the electro-activator 50 is connected to the photocatalytic oxidation apparatus 20. The fluid passes through the electro-activator and the photocatalytic oxidation apparatus during operation. Preferably, the electro-activator 50 is positioned upstream from the photocatalytic oxidation apparatus 20. As a result, the fluid passes through the electro-activator 50 before passing through the photocatalytic oxidation apparatus 20. The arrows illustrate the flow directions of the fluid.

When passing through the electro-activator 50, the fluid is electrolyzed by an electric field between the anode 64 and the cathode 66. Preferably, the electric field has an electric voltage ranging from about 5 to about 100 Volts and an electric density ranging from about 1 to about 1000 mA/cm². The scaling ions (e.g. calcium ions, magnesium ions, or combination thereof) in the fluid can be converted to particles (e.g. CaCO₃, MgCO₃, or combination thereof) through the following chemical reactions.
Ca²⁺+CO₃²⁻→CaCO₃ (granules)
Mg²⁺+CO₃²⁻→MgCO₃ (granules)

The particles (e.g. CaCO₃, MgCO₃, or combination thereof) generally have even and round shapes, which do not adhere to the titanium dioxide-coated surfaces of the photocatalytic oxidation apparatus 20 and can be removed by a filter. As a result, water scales are prevented from being generated on the titanium dioxide-coated surfaces of the photocatalytic oxidation apparatus 20, and sufficient ultraviolet light from the ultraviolet lamp 38 could directly irradiate the titanium dioxide coated surfaces to cause photocatalytic oxidation reaction. The electric filed between the anode 64 and the cathode 66 also generates chemically active substances (e.g. HClO, O₂⁻, OH., H₂O₂, or combination thereof) through the following chemical reactions.
2Cl⁻+2e⁻→Cl₂
Cl₂+H₂O→HOCl+HCl
HOCl+H₂O→H₃O⁺+OCl⁻
O₂+H₂O+2e→HO₂⁻+OH⁻
HO₂⁻→OH⁻+O.
O.+O₂→O₃
O₃+H₂O→2HO₂.
O_{3+HO}₂.→HO.+2O₂
As a result, the photocatalytic activity inside the photocatalytic oxidation apparatus 20 is enhanced.

Using the electro-activator 50 with the photocatalytic oxidation apparatus 20, the efficiency of the photocatalytic oxidation reaction is enhanced significantly. Experiments show that the germ-killing rate can be increased from about 90% to about 99% and the biocide rate can be increased from about 51.9% to about 99.7%.

The following test results illustrate the efficiency of the catalytic system 10 of the present invention.

### Test Results I

Sample—River water collected from the tributary of Peal River (Dongguan section).

Test Procedures—Waterborne total bacterial count (TBC) techniques were used in accordance with the American Public Health Association standard methods.

Date of Test—23 Feb. 2004˜26 Feb. 2004

Results—

| | | | | Photocatalytic |
|---|---|---|---|---|
| | | Photocatalytic | Eectro- | Oxidation and |
| | Without | Oxidation | Ativator | Eectro-Ativator |
| Sample | Treatment | Treated | Treated | Treated |
| TBC | 3.0 × 10³ | 1.0 × 10³ | 1.3 × 10³ | 3.0 × 10¹ |
| (cell/100 mL) | | | | |

### Test Results II

Sample—River water collected from the tributary of Peal River (Dongguan section).

Test Procedures—Waterborne unicellular algae enumeration techniques were used in accordance with the American Public Health Association standard methods. The techniques include direct microscopic count and indirect 5-day culture using culture medium No. 4.

Date of Test—26 Feb. 2004˜6 Mar. 2004

Results—

| | | | | Photocatalytic |
|---|---|---|---|---|
| | | Photocatalytic | Eectro- | Oxidation and |
| | Without | Oxidation | Ativator | Eectro-Ativator |
| Sample | Treatment | Treated | Treated | Treated |
| Direct Count | 2.3 × 10⁴ | 1.6 × 10⁴ | 1.8 × 10⁴ | 1.5 × 10⁴ |
| (cell/100 mL) | | | | |
| Indirect Count | 3.2 × 10⁵ | 1.7 × 10⁵ | 2.0 × 10⁴ | 1.6 × 10⁴ |
| (cell/100 mL) | | | | |

All patents and patent applications disclosed herein, including those disclosed in the background of the invention, are hereby incorporated by reference. Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention.

1. A catalytic system for enhancing photocatalytic oxidation reaction in a fluid environment comprising:
a photocatalytic oxidation apparatus comprising a container adapted to accommodate passing through fluid and a titanium dioxide-coated surface for receiving light; and
an electro-activator in connection with said photocatalytic oxidation apparatus, said electro-activator comprising a pair of electrodes adapted to create an electric field and being adapted to accommodate said passing through fluid.

2. The catalytic system according to claim 1 wherein said electro-activator is positioned upstream from said photocatalytic oxidation apparatus and said electrodes includes an anode and a cathode, said anode having a semiconductor material capable of:
generating one or more chemically active substances to the fluid to enhance photocatalytic activity of the photocatalytic oxidation apparatus; and
converting scaling ions in the fluid to particles that do not adhere to the titanium dioxide-coated surface of the photocatalytic oxidation apparatus to prevent scaling thereof.

3. The catalytic system according to claim 2 wherein the anode is coated with the semiconductor material.

4. The catalytic system according to claim 3 wherein the anode is constructed of titanium coated with ruthenium oxide, iridium oxide, manganese oxide, nickel oxide, or combination thereof.

5. The catalytic system according to claim 3 wherein the anode further includes Gadolinium.

6. The catalytic system according to claim 2 wherein the scaling ions includes calcium ions, magnesium ions, or combination thereof.

7. The catalytic system according to claim 2 wherein the particles has a generally even shape.

8. The catalytic system according to claim 2 wherein the particles includes CaCO₃, MgCO₃, or combination thereof.

9. The catalytic system according to claim 2 wherein the chemically active substances includes HClO, O₂⁻, OH., H₂O₂, or combination thereof.

10. The catalytic system according to claim 1 wherein the electric field has an electric voltage ranging from about 5 to about 100 Volts.

11. The catalytic system according to claim 1 wherein the electric field has an electric density ranging from about 1 to about 1000 mA/cm².

12. A method of enhancing photocatalytic oxidation reaction in a fluid environment comprising:
(a) passing fluid through a purification device or system;
(b) subjecting said fluid to a process of photocatalytic oxidation for purifying or disinfecting said fluid;
(c) generating and releasing one or more chemically active substances to said fluid for enhancing photocatalytic activity of said process of photocatalytic oxidation;
(d) converting one or more scaling ions in said fluid to one or more non-adhering particles; and
step (b) to step (d) are performed in any order.

13. The method according to claim 12 wherein step (c) is accomplished by using an electro-activator.

14. The method according to claim 12 wherein step (b) is accomplished by using a photocatalytic oxidation apparatus.

15. The method according to claim 12 wherein said chemically active substances include HClO, O₂⁻, OH., H₂O₂, or combination thereof.

16. The method according to claim 12 wherein said particles includes CaCO₃, MgCO₃, or combination thereof.
